(19) United States
(12) Patent Application Publication
(10) Pub. No.: US 2005/0288990 A1
(43) Pub. Date: Dec. 29, 2005

(54) Computer-implemented method, system and program product for modeling a consumer decision process

(75) Inventors: Steven E. Ballou, Oviedo, FL (US); Todd Gurley, St. Louis, MO (US); Jason R. Hill, Florissant, MO (US); Joseph D. Kramer, Passaic, NJ (US); Richard D. Maltsbarger, Mooresville, NC (US); Sunil J. Noronha, Chappaqua, NY (US)

Correspondence Address: HOFFMAN WARNICK & D'ALESSANDRO, LLC, 75 STATE STREET, 14TH FL, ALBANY, NY, 12207, US

(73) Assignee: International Business Machines Corporation, Armonk, NY (US)

(21) Appl. No.: 10/875,692

(22) Filed: Jun. 24, 2004

(51) Int. Cl. G06F 17/60

(52) U.S. Cl. 705/10; 705/1

(57) ABSTRACT

Under the present invention information corresponding to a purchase decision is qualitatively collected (e.g., through in-depth interviews) from a first set of consumers. The information is used to determine the complete set of elements that impact the purchase decision. Thereafter, a process map is developed that incorporates the elements and the decision stages in the consumer decision process. The set of elements is then quantitatively validated based on survey data received from a second, bigger set of consumers. If the set of elements are validated, they will be mapped to the set of decision stages based on the survey data, and assigned impact scores. Based on the mapping and the scores, a global map that models the consumer decision process is developed.

### BACKGROUND OF THE INVENTION

1. Field of the Invention

In general, the present invention provides a computer-implemented method, system and program product for modeling a consumer decision process. Specifically, the process invention provides a way to objectively quantify the impact of specific customer actions and market influences on a consumer's purchase decision.

2. Related Art

Understanding the elements of the consumer decision process has long been a goal of business as one of the important keys to better targeting of marketing, customer service, overall business strategy, and other customer-impacting operations. Recent surveys have suggested that many businesses plan to focus on revenue growth as the key factor in improving their market position over the next few years. One area of focus for creating revenue growth is the identification of new goods/services. However, realizing fast and efficient growth requires capturing a greater share of the existing customer base, and introducing goods/services into the proper channels and markets. To do this, businesses need a better understanding of the consumer decision process. Unfortunately, decision making is an extremely complex and difficult process to quantify, especially in categories where the goods/services are complex and the purchase process is typically long.

Historically, there has been no truly reliable way to quantify the priority and impact of elements on how, when and where a consumer finally purchases a product. The complexity of the process is in at least four dimensions: (1) the stages though which a consumer passes in making a purchase decision; (2) the elements (e.g., needs, activities or attributes) that comprise a stage; (3) the impact of an element on a stage and, ultimately, on the final decision; and (4) identifying the most important moments of a purchase decision (e.g., the timing).

To date, much qualitative research has been done in this area. However, given the limited nature of qualitative research (e.g., scale, scope, etc.), the results have not been projectible up to a market-level population or target audience. As such, no previous system has provided an accurate was to model or predict the consumer decision process. That is, no existing system provides a quantitative approach to understanding the consumer decision process. Such an approach could yield a more accurate and reliable model upon which businesses can base their own strategic decisions.

In view of the foregoing, there exists a need for a computer-implemented method, system and program product for modeling a consumer decision process. Specifically, a need exists for a system to quantitatively validate hypotheses that are developed using qualitative methods. A further need exists for a system that is capable of determining the elements that impact a purchase decision, and the decision stages in the decision process. Still yet, a need exists for a system that can map the elements to the stages, and weight them accordingly so that a model of the consumer decision process can be developed.

### SUMMARY OF THE INVENTION

In general, the present invention provides a computer-implemented method, system and program product for (quantitatively) modeling a consumer decision process. Specifically, under the present invention information corresponding to a purchase decision is qualitatively collected (e.g., through in-depth interviews) from a first set of consumers. The information is used to determine the complete set of elements that impact the purchase decision. Thereafter, a process map is developed that incorporates the elements and the decision stages in the consumer decision process. The set of elements is then quantitatively validated based on survey data received from a second, bigger set of consumers. If the set of elements are validated, they will be mapped to the set of decision stages based on the survey data, and assigned impact scores. Based on the mapping and the scores, a global map that models the consumer decision process is developed.

A first aspect of the present invention provides a computer-implemented method for modeling a consumer decision process, comprising: receiving information corresponding to a purchase decision from a first set of consumers, and using the information to determine a set of elements that impact the purchase decision; determining a set of decision stages in the consumer decision process based on the set of elements; quantitatively validating the set of elements based on survey data received from a second set of consumers; mapping the set of elements to the set of decision stages after the validating; and assigning impact scores to each of the set of elements for each of the set of decision stages.

A second aspect of the present invention provides a system for modeling a consumer decision process, comprising: an input reception system for receiving information corresponding to a purchase decision from a first set of consumers; an element determination system for using the information to determine a set of elements that impact the purchase decision; a decision stage system for determining a set of decision stages in the consumer decision process based on the set of elements; a validation system for validating the set of elements based on survey data received from a second set of consumers; an element mapping system for mapping the set of elements to the set of decision stages after the validating; and an element scoring system for assigning impact scores to each of the set of elements for each of the set of decision stages.

A third aspect of the present invention provides a program product stored on a recordable medium for modeling a consumer decision process, which when executed, comprises: program code for receiving information corresponding to a purchase decision from a first set of consumers; program code for using the information to determine a set of elements that impact the purchase decision; program code determining a set of decision stages in the consumer decision process based on the set of elements; program code for validating the set of elements based on survey data received from a second set of consumers; program code for mapping the set of elements to the set of decision stages after the validating; and program code for assigning impact scores to each of the set of elements for each of the set of decision stages.

A fourth aspect of the present invention provides a system for deploying an application for modeling a consumer decision process, comprising: a computer infrastructure being operable to: receive information corresponding to a purchase decision from a first set of consumers, and using the information to determine a set of elements that impact the purchase decision; determine a set of decision stages in the consumer decision process based on the set of elements; validate the set of elements based on survey data received from a second set of consumers; map the set of elements to the set of decision stages after the validating; and assign impact scores to each of the set of elements for each of the set of decision stages.

A fifth aspect of the present invention provides computer software embodied in a propagated signal for deploying an application for modeling a consumer decision process, the computer software comprising instructions to cause a computer system to perform the following functions: receive information corresponding to a purchase decision from a first set of consumers, and using the information to determine a set of elements that impact the purchase decision; determine a set of decision stages in the consumer decision process based on the set of elements; validate the set of elements based on survey data received from a second set of consumers; map the set of elements to the set of decision stages after the validating; and assign impact scores to each of the set of elements for each of the set of decision stages.

Therefore, the present invention provides a computer-implemented method, system and program product for modeling a consumer decision process.

### BRIEF DESCRIPTION OF THE DRAWINGS

These and other features of this invention will be more readily understood from the following detailed description of the various aspects of the invention taken in conjunction with the accompanying drawings in which:

FIG. 1 depicts a system for quantitatively modeling a consumer decision process according to the present invention.

FIG. 2 depicts a chart of illustrative elements according to the present invention.

FIG. 3 depicts an illustrative process map according to the present invention.

FIG. 4 depicts an illustrative generation of survey questions according to the present invention.

FIG. 5 depicts an illustrative mapping of elements to decision stages according to the present invention.

FIG. 6 depicts an illustrative assigning of scores to elements that have been mapped to decision stages according to the present invention.

FIG. 7 depicts a global map representing a model of the consumer decision process according to the present invention.

FIG. 8 depicts a diagram of conclusions can be drawn from the global map of FIG. 7, and associated company actions that can be taken based thereon according to the present invention.

The drawings are not necessarily to scale. The drawings are merely schematic representations, not intended to portray specific parameters of the invention. The drawings are intended to depict only typical embodiments of the invention, and therefore should not be considered as limiting the scope of the invention. In the drawings, like numbering represents like elements.

### DETAILED DESCRIPTION OF THE INVENTION

For convenience purposes, the Detailed Description of the Invention will have the following sections:

I. General Description

II. Computer Implementation

I. General Description

As indicated above, the present invention provides a computer-implemented method, system and program product for (quantitatively) modeling a consumer decision process. Specifically, under the present invention information corresponding to a purchase decision is qualitatively collected (e.g., through in-depth interviews) from a first set of consumers. The information is used to determine the complete set of elements that impact the purchase decision. Thereafter, a process map is developed that incorporates the elements and the decision stages in the consumer decision process. The set of elements is then quantitatively validated based on survey data received from a second, bigger set of consumers. If the set of elements are validated, they will be mapped to the set of decision stages based on the survey data, and assigned impact scores. Based on the mapping and the scores, a global map that models the consumer decision process is developed.

It should be understood in advance that the teachings of the present invention will be described below in conjunction with the purchase of an appliance. However, it should also be understood that this is intended as an illustrative example only, and that the present invention could be applied to the purchase of any type of goods/services.

II. Computerized Implementation

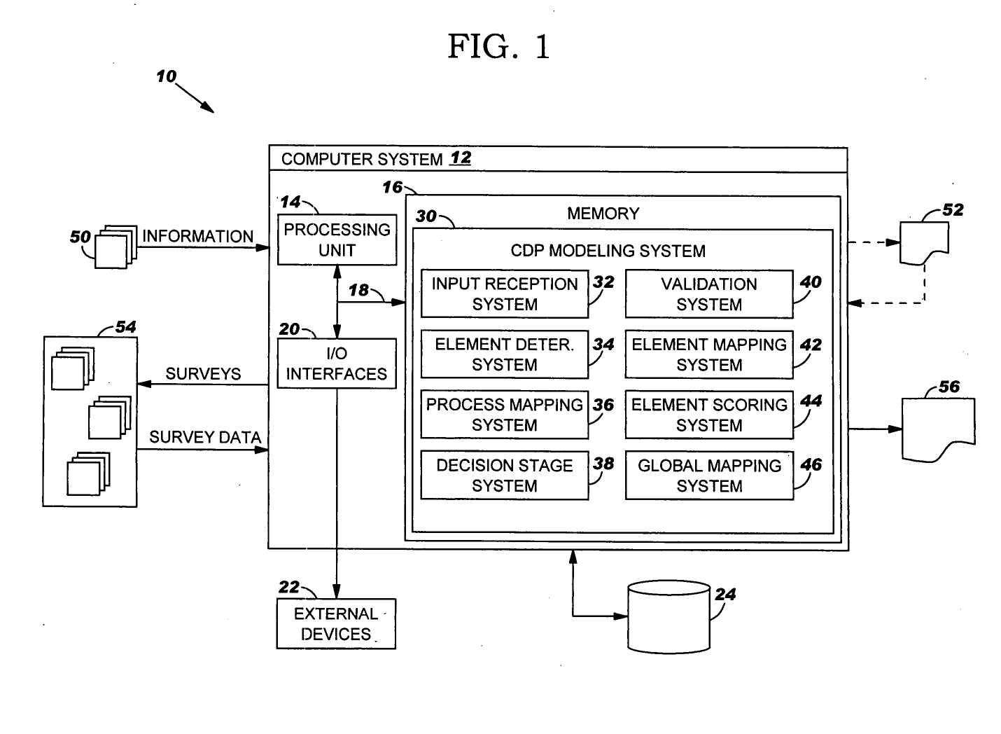

Referring now to FIG. 1, a system 10 for modeling a consumer decision process (CDP) is shown. As depicted, system 10 includes computer system 12 that carries out the functions of the present invention. In general, computer system 12 is intended to represent any type of computer system that is capable of modeling a CDP accordance with the present invention. For example, computer system 12 could be a desktop computer, a laptop, a workstation. Moreover, the teachings recited herein could be implemented on a stand-alone computer system (as shown), or over a network. In the case of the latter, computer system 12 could be a client or a server. Also, the network could be any type of network such as the Internet, a local area network (LAN), a wide area network (WAN), a virtual private network (VPN), etc. Communication throughout the network could occur via a direct hardwired connection (e.g., serial port), or via an addressable connection that may utilize any combination of wireline and/or wireless transmission methods. Moreover, conventional network connectivity, such as Token Ring, Ethernet, WiFi or other conventional communications standards could be used. Still yet, connectivity could be provided by conventional TCP/IP sockets-based protocol. In this instance, an Internet service provider could be used to establish interconnectivity.

As depicted, computer system 12 generally includes processing unit 14, memory 16, bus 18, input/output (I/O) interfaces 20, external devices/resources 22 and storage unit 24. Processing unit 14 may comprise a single processing unit, or be distributed across one or more processing units in one or more locations, e.g., on a client and server. Memory 16 may comprise any known type of data storage and/or transmission media, including magnetic media, optical media, random access memory (RAM), read-only memory (ROM), a data cache, a data object, etc. Moreover, similar to processing unit 14, memory 16 may reside at a single physical location, comprising one or more types of data storage, or be distributed across a plurality of physical systems in various forms.

I/O interfaces 20 may comprise any system for exchanging information to/from an external source. External devices/resources 22 may comprise any known type of external device, including speakers, a CRT, LED screen, hand-held device, keyboard, mouse, voice recognition system, speech output system, printer, monitor/display, facsimile, pager, etc. Bus 18 provides a communication link between each of the components in computer system 12 and likewise may comprise any known type of transmission link, including electrical, optical, wireless, etc.

Storage unit 24 can be any system (e.g., a database, etc.) capable of providing storage for information As such, storage unit 24 could include one or more storage devices, such as a magnetic disk drive or an optical disk drive. In another embodiment, storage unit 24 includes data distributed across, for example, a local area network (LAN), wide area network (WAN) or a storage area network (SAN) (not shown). Although not shown, additional components, such as cache memory, communication systems, system software, etc., may be incorporated into computer system 12.

Shown in memory 16 is CDP modeling system 30, which includes input reception system 32, element determination system 34, process mapping system 36, decision stage system 38, validation system 40, element mapping system 42, element scoring system 44 and global mapping system 46. These systems represent program code that facilitate the CDP modeling process of the present invention.

In a typical embodiment, the process begins by receiving information from a set of consumers 50 about a purchase decision. In an illustrative example, assume the purchase decision focuses on a home appliance. This information gathering step is generally performed qualitatively and is conducted based on one-on-one interviews. To this extent, the information can be manually keyed into computer system 12 by an administrator or the like, or the interviews could be individually conducted with set of consumers 50 directly over a network or the like. In any event, the information (e.g., interview data) will be received by input reception system 32 and used to generate an initial hypothesis (or hypotheses) about the CDP. The one-on-one interviews differ from traditional qualitative research in that they are entirely emergent or completely open-ended interviews. This helps avoid any bias of a research team's myopic questions about what set of consumers 50 did or did not like about a good/service. In addition, this approach allows set of consumers 50 to be frank about their experiences and not guided by the responses of others. Still yet, very few limitations could be used to prequalify consumers so that the broadest cross-section of a company's target consumer base can be selected.

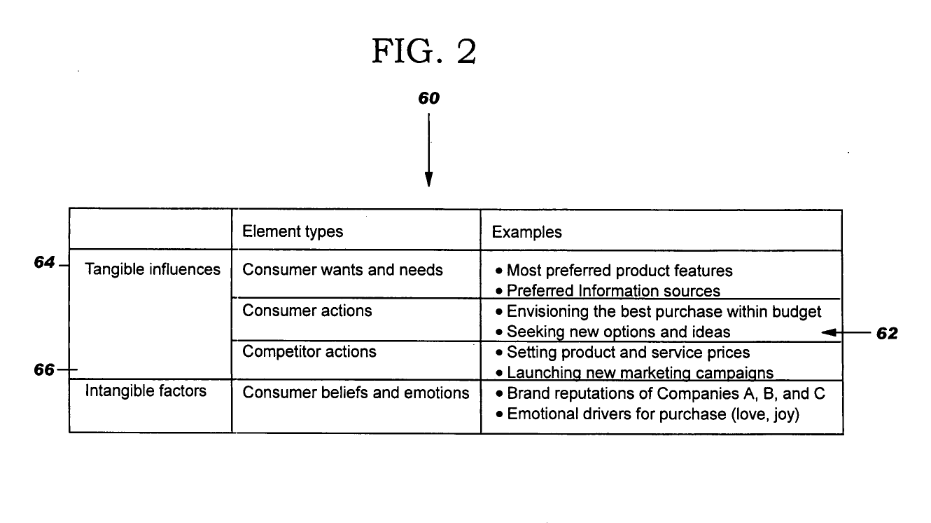

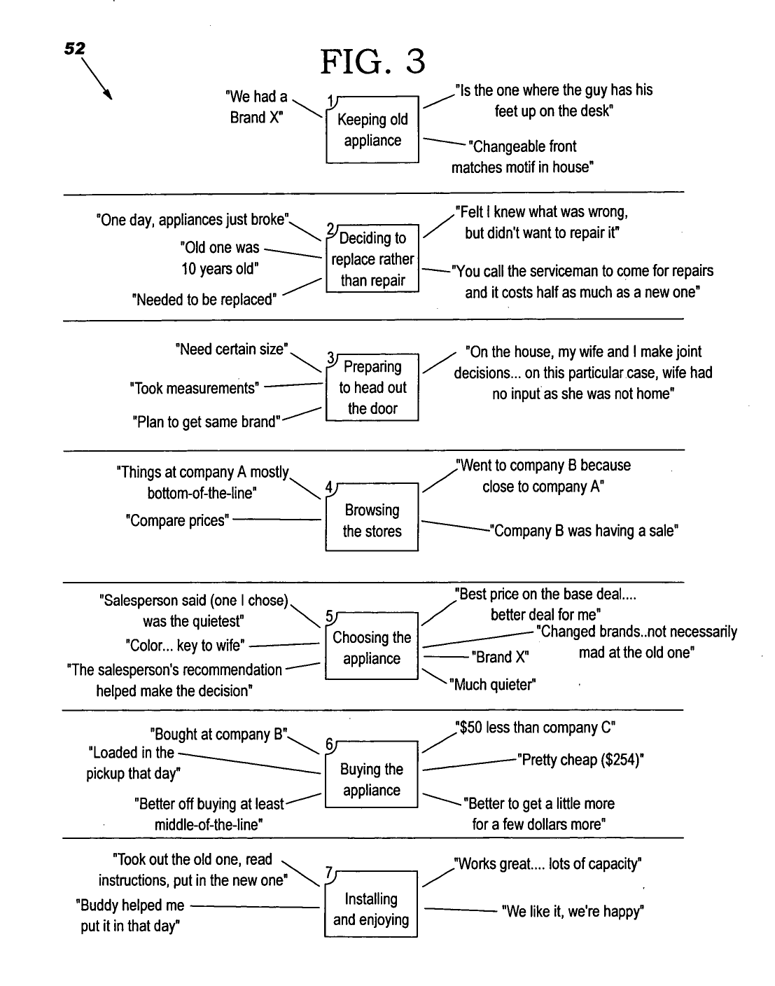

Once the interview information has been received from set of consumers 50, element determination system 34 will parse the same to determine the elements that impact purchase decisions. Such elements include both hard influences (e.g., consumer needs, consumer actions, competitor actions, etc.) and soft influences (e.g., consumer beliefs and emotions. Referring now to FIG. 2, a table 60 of example elements 62 are depicted. As shown, the table 60 depicts both hard (tangible) influences 64 and intangible (e.g., soft) influences 66. Referring back to FIG. 1, once the elements have been determined, process mapping system 36 will convert the elements in a process map 52. A more detailed depiction of the illustrative process map 52 is shown in FIG. 3. As can be seen, the elements determined by element determination system 34 (FIG. 1) have been summarized into categories (1-7) based on the interview responses. Referring back to FIG. 1, process map 52 will then be summarized by decision stage system 38 into a set of decision stages that a consumer passes through in making a purchase decision.

In this illustrative example, the following stages could be determined:

A. Incubation: Consumers have identified a need and are actively seeking options for a purchase, but for various reasons are not ready to buy or are delaying the purchase. Researchers have found that the incubation stage for complex purchases can last for a number of years—a window of opportunity that companies focused on the quick sale could be neglecting. For example, in FIG. 3, the (1) “keeping old appliance” category would fall into the incubation stage.

B. Trigger: Any number of events—including the breakdown or poor performance of a product, receipt of a new credit line, a windfall from a raise or bonus at work, the birth of a child or even an upcoming social event—triggers transition from the Incubation mode to the next stage—Shopping and Purchase. The consumer is still seeking information, taking measurements and weighing product features and other variables—such as the immediacy of their need or their ability to delay gratification—even as they head out the door. For example, in FIG. 3, the (2) “deciding to replace rather than repair” and (3) “preparing to head out the door” categories would be fall into the trigger stage.

C. Shopping and purchase: Consumers shop with an intent to buy, choose and purchase a product. Consumers make the crucial price-to-value tradeoffs during final product selection and shopping, and ultimately purchase, at those companies that made positive influences during incubation. For example, in FIG. 3, the (4) “browsing the stores”, (5) “choosing the appliance” and (6) “buying the appliance” categories would fall in the shopping and purchase stage.

D. Post-purchase expectations: Consumers evaluate expectations of after-sales issues such as product performance, and installation, repair or warranty services even before making the final purchase decision. Failure to adequately position a company's ability to deliver after-sales service can cause loss of current as well as future sales. During actual post-purchase, which could again be a several-year process, the consumer assesses their overall satisfaction with the product. Most importantly, these post-purchase assessments become a feedback mechanism into the series of “incubating” purchases that are to follow. For example, in FIG. 3, the (7) “installing and enjoying” category would be fall into the post-purchase expectations stage.

Referring back to FIG. 1, once the set of decision stages have been determined, validation system 40 will validate the initial hypothesis (e.g., the set of elements determined and resulting decision stages). This is typically accomplished on a quantitative basis by surveying a bigger set of consumers 54. In a typical embodiment, the survey questions are built directly from elements defined in the initial qualitative research process (e.g., the interviews of set of consumers 50). Specifically, the market survey assesses the percent of consumers whose decision processes were affected by each element—validating how consumers make decisions to create a market representative view of the consumer decision process. The volume of respondents participating in the quantitative surveys (e.g., typically from 400 to as many as 1,600) consumers—validate which actions and influences have the broadest effects on the marketplace and provide the depth of information necessary to pattern trends in consumer decision processes. The survey is structured around the stages and covers areas such as:

Incubation Stage:

When did you first start thinking about buying a new product/service?

What actions did you take during the period of time before you decided to purchase the new product/service?

Trigger Stage:

Thinking about your purchase, what best describes why you chose to purchase the new product/service at this time?

Shopping and Purchase Stage:

Which product features were in your decision to select your new product/service?

Which attributes about retailers were in your decision to shop at specific retailers for your new product/service?

Post-Purchase Expectations Stage:

What best describes how you installed your new product/service?

How satisfied were you with the retailers' after-sales service?

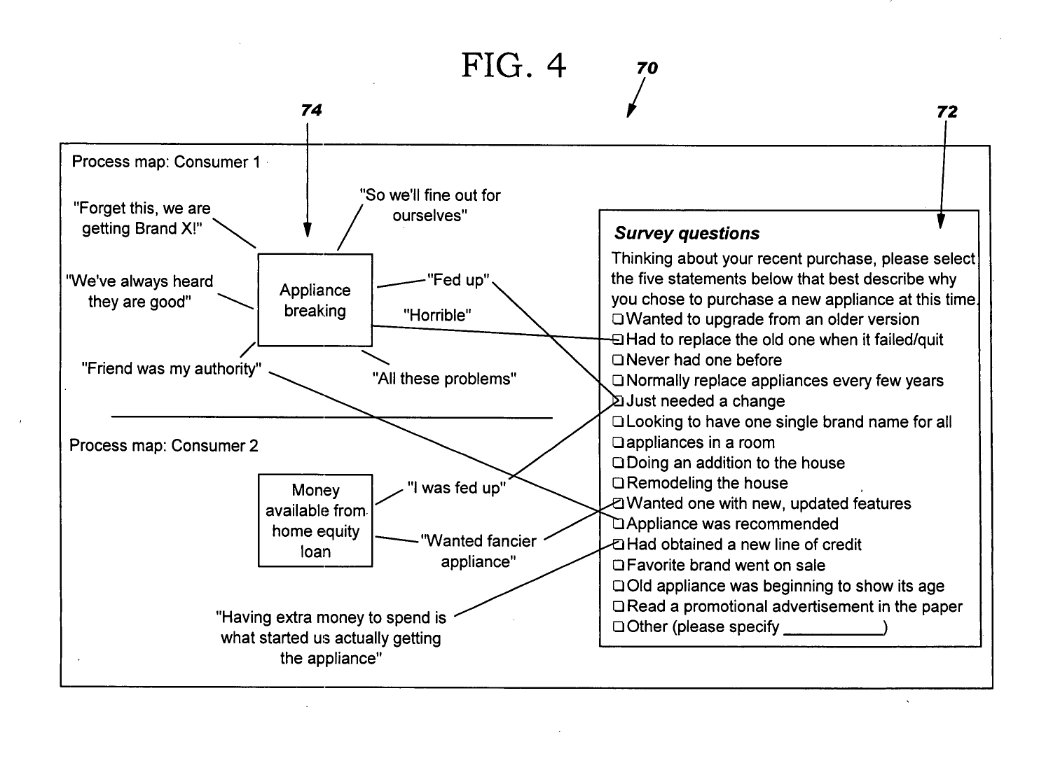

Referring to FIG. 4, a more detailed illustrative diagram 70 depicting the generation of survey questions 72 from elements 74 is shown. Under the present invention, the survey can be generated manually by an administrator or the like, or it can be generated automatically by validation system 40. In either event the survey will be provided to set of consumers 54, and their corresponding responses (i.e., survey data) will be received (e.g., by input reception system 32). Based on the survey data, validation system 40 will attempt to statistically validate the initial set of elements and stages that were determined (i.e., validate the initial hypothesis).

Referring back to FIG. 1, assuming that the initial hypothesis is validated, element mapping system 42 will develop a quantitative model to prioritize the impact of the elements on the purchase decision. Specifically, element mapping system 42 will use the survey data to map how product selection and the decision stages impact the “target” consumer decision most important to the company

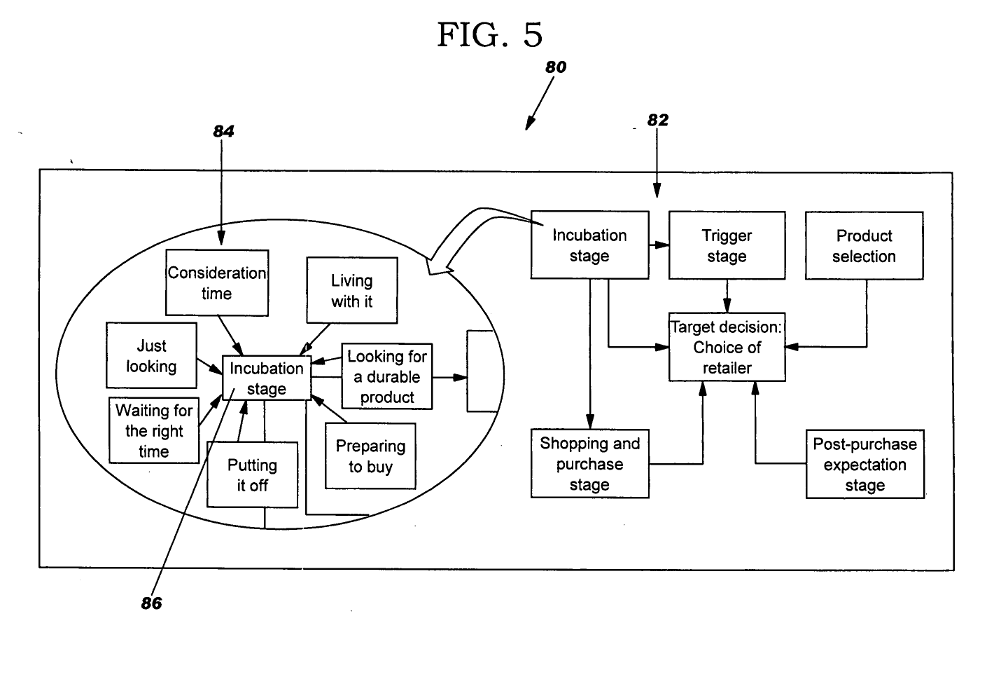

Next, element mapping system 42 will map the elements that impact product selection to each decision stage. Referring to FIG. 5, an illustrative mapping 80 is shown. Mapping 80 generally includes decision stages 82 as associated with the elements that were deemed to have an impact thereon. For example, since elements 84 were deemed to impact the “Incubation” decision stage 86, they were mapped together accordingly.

Referring back to FIG. 1, after the mapping has been completed, element scoring system 44 will assign relative scores to each element for each decision stage. That is, each element (as mapped) will be weighted to reflect its relative impact on the particular decision stage. Specifically, element scoring system 44 utilizes leading-edge analytics to objectively identify which elements exert the most influence over the purchase decision for the particular decision stage. Scoring can be assigned based on an impact scale that ranges, for example, from critical to negligible. In a typical embodiment, the scoring of elements can be conducted as follows:

Structural equation modeling (SEM) is used to convert the mappings (such as that shown in FIG. 5) into a quantitative model based on how many consumers take an action versus how many buy from a particular company.

Path regressions can be used to test thousands of relationships between elements and decisions and utilize cross-validation testing to find the model that has the “best fit” for explaining why consumers make specific decisions.

Impact scores utilizing a standardized scale based on the SEM's coefficients to prioritize the relative “impact” of an element on the final purchase decision will then be assigned.

Score mapping assigns an “impact” to every element-to-stage and stage-to-decision link in the maps to identify which linkages ultimately impact the final decision.

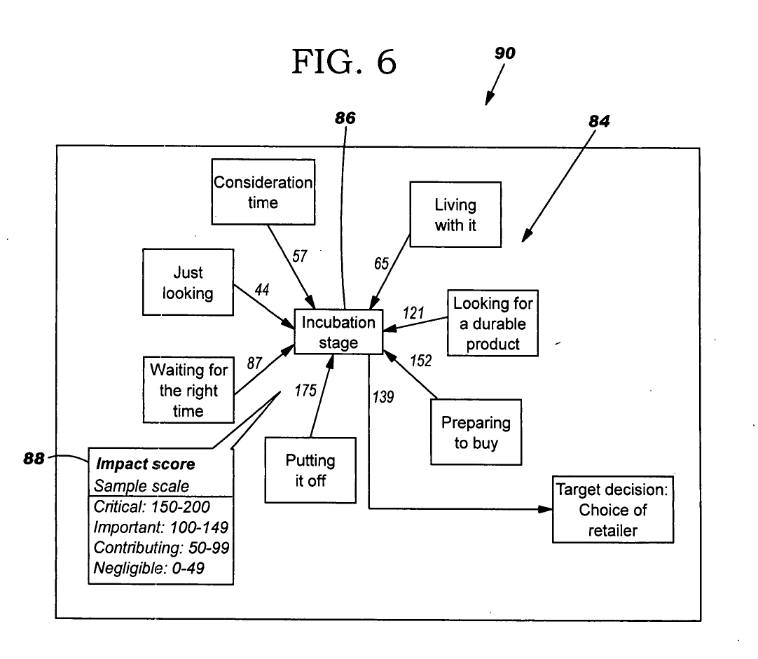

Referring to FIG. 6, an illustrative diagram 90 depicting the assignment of scores to element 84 for “Incubation” decision stage 86 is shown. As can be seen, the scores have been assigned based on a scale 88 of their relative impact on “Incubation” decision stage 86.

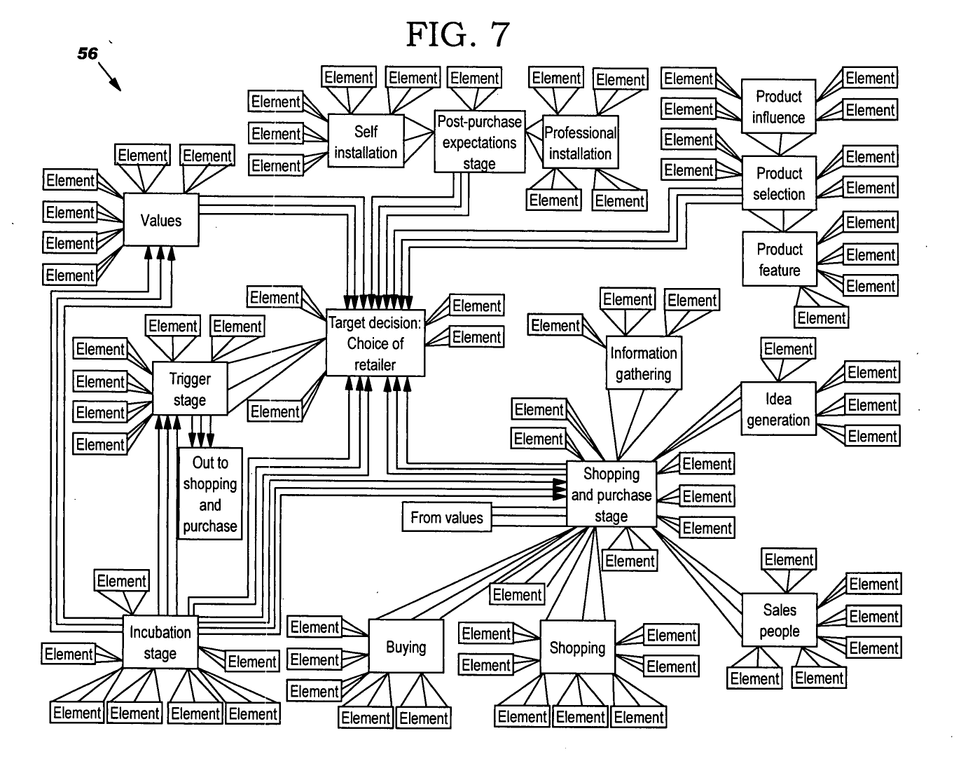

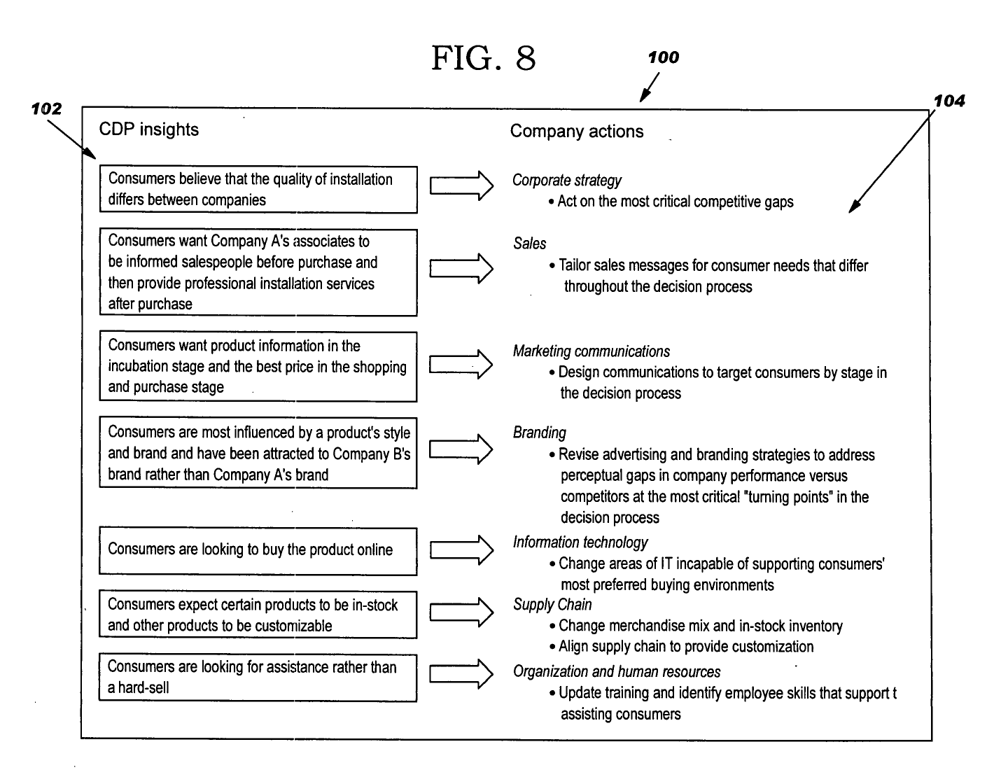

After the scores have been assigned for each element of each decision stage, global mapping system 46 will develop a global map 56 based thereon. FIG. 7 depicts global map 56 in greater detail. As can be seen, all elements have been mapped to their decision stages. Also, similar to FIG. 6, each element will be assigned a relative score for each decision stage. However, such scores are not depicted in FIG. 7 for clarity and simplicity purposes. In any event, global map 56 will thus present the company with, clear and concise quantitative representation of exactly what element have the greatest impact on each decision stage. This could then be used to drive the desired growth of the company. That is, the output provided by the present invention can be used as a resource to determine a course of actions to take to best optimize growth and any other desired corporate goal. Referring to FIG. 8, an illustrative diagram 100 depicting the conclusions 102 that can be drawn from global map 56 (FIG. 7) and associated company actions 104 that can be taken based thereon are shown. For example, for the conclusion “Consumers believe that the quality of installation differs between companies,” a resulting action could be to “act on the most critical competitive gaps.”

It should be appreciated that the teachings of the present invention could be offered as a business method on a subscription or fee basis. For example, computer system 12 of FIG. 1 could be created, maintained and/or deployed by a service provider that offers the functions described herein for customers. That is, a service provider could offer to test a server environment of a customer by driving a load and analyzing the resulting performance as describe above. It should also be understood that the present invention can be realized in hardware, software, a propagated signal, or any combination thereof Any kind of computer/server system(s)—or other apparatus adapted for carrying out the methods described herein—is suited. A typical combination of hardware and software could be a general purpose computer system with a computer program that, when loaded and executed, carries out the respective methods described herein. Alternatively, a specific use computer, containing specialized hardware for carrying out one or more of the functional tasks of the invention, could be utilized. The present invention can also be embedded in a computer program product or a propagated signal, which comprises all the respective features enabling the implementation of the methods described herein, and which—when loaded in a computer system—is able to carry out these methods. Computer program, propagated signal, software program, program, or software, in the present context mean any expression, in any language, code or notation, of a set of instructions intended to cause a system having an information processing capability to perform a particular function either directly or after either or both of the following: (a) conversion to another language, code or notation; and/or (b) reproduction in a different material form.

The foregoing description of the preferred embodiments of this invention has been presented for purposes of illustration and description. It is not intended to be exhaustive or to limit the invention to the precise form disclosed, and obviously, many modifications and variations are possible. Such modifications and variations that may be apparent to a person skilled in the art are intended to be included within the scope of this invention as defined by the accompanying claims. For example, the configuration of CDP modeling system 30 of FIG. 1 is intended to be illustrative only. As such, CDP modeling system 30 could be represented by a different configuration of systems.

1. A computer-implemented quantitatively method for modeling a consumer decision process, comprising:
receiving information corresponding to a purchase decision from a first set of consumers, and using the information to determine a set of elements that impact the purchase decision;
determining a set of decision stages in the consumer decision process based on the set of elements;
quantitatively validating the set of elements based on survey data received from a second set of consumers;
mapping the set of elements to the set of decision stages after the validating; and
assigning impact scores to each of the set of elements for each of the set of decision stages.

2. The computer-implemented method of claim 1, further comprising modeling the consumer decision process by developing a global map based on the mapping and the assigning steps.

3. The computer-implemented method of claim 1, wherein the determining step comprises:
converting the set of elements into a process map; and
summarizing the process map into the set of decision stages.

4. The computer-implemented method of claim 1, wherein the using step comprises qualitatively developing an initial hypothesis for the consumer decision process using the information, and wherein the quantitatively validating step comprises quantitatively validating the initial hypothesis using the survey data.

5. The computer-implemented method of claim 1, wherein the first set of consumers is smaller than the second set of consumers.

6. The computer-implemented method of claim 1, wherein the impact scores are assigned based on a scale to prioritize a relative impact of the set of elements on the set of decision stages to which they are mapped.

7. The computer-implemented method of claim 1, wherein the survey data is collected based on a survey provided to the second set of consumers, and wherein questions in the survey are generated based on the set of elements.

8. A system for modeling a consumer decision process, comprising:
an input reception system for receiving information corresponding to a purchase decision from a first set of consumers;
an element determination system for using the information to determine a set of elements that impact the purchase decision;
a decision stage system for determining a set of decision stages in the consumer decision process based on the set of elements;
a validation system for validating the set of elements based on survey data received from a second set of consumers;
an element mapping system for mapping the set of elements to the set of decision stages after the validating; and
an element scoring system for assigning impact scores to each of the set of elements for each of the set of decision stages.

9. The system of claim 8, further comprising a global mapping system for modeling the consumer decision process by developing a global map based on the mapping and the impact scores.

10. The system of claim 8, further comprising a process mapping system for converting the set of elements into a process map, wherein the decision stage system summarizes the process map into the set of decision stages.

11. The system of claim 8, wherein the element determination system qualitatively develops an initial hypothesis for the consumer decision process using the information, and wherein the hypothesis validation system quantitatively validates the initial hypothesis using the survey data.

12. The system of claim 8, wherein the first set of consumers is smaller than the second set of consumers.

13. The system of claim 8, wherein the element scoring system assigns the impact scores based on a scale to prioritize a relative impact of the set of elements on the set of decision stages to which they are mapped.

14. The system of claim 8, wherein the survey data is collected based on a survey provided to the second set of consumers, and wherein questions in the survey are generated based on the set of elements.

15. A program product stored on a recordable medium for modeling a consumer decision process, which when executed, comprises:
program code for receiving information corresponding to a purchase decision from a first set of consumers;
program code for using the information to determine a set of elements that impact the purchase decision;
program code determining a set of decision stages in the consumer decision process based on the set of elements;
program code for validating the set of elements based on survey data received from a second set of consumers;
program code for mapping the set of elements to the set of decision stages after the validating; and
program code for assigning impact scores to each of the set of elements for each of the set of decision stages.

16. The program product of claim 15, further comprising program code for modeling the consumer decision process by developing a global map based on the mapping and the impact scores.

17. The program product of claim 15, further comprising program code for converting the set of elements into a process map, wherein the program code for determining the set of decision stages summarizes the process map into the set of decision stages.

18. The program product of claim 15, wherein the program code for using the information qualitatively develops an initial hypothesis for the consumer decision process using the information, and wherein the program code for validating quantitatively validates the initial hypothesis using the survey data.

19. The program product of claim 15, wherein the first set of consumers is smaller than the second set of consumers.

20. The program product of claim 15, wherein the program code for assigning assigns the impact scores based on a scale to prioritize a relative impact of the set of elements on the set of decision stages to which they are mapped.

21. The program product of claim 15, wherein the survey data is collected based on a survey provided to the second set of consumers, and wherein questions in the survey are generated based on the set of elements.

22. A system for deploying an application for modeling a consumer decision process, comprising:
a computer infrastructure being operable to:
receive information corresponding to a purchase decision from a first set of consumers, and using the information to determine a set of elements that impact the purchase decision;
determine a set of decision stages in the consumer decision process based on the set of elements;
validate the set of elements based on survey data received from a second set of consumers;
map the set of elements to the set of decision stages after the validating; and
assign impact scores to each of the set of elements for each of the set of decision stages.

23. The system of claim 22, wherein the computer infrastructure is further operable to model the consumer decision process by developing a global map based on the mapping and the impact scores.

24. Computer software embodied in a propagated signal for deploying an application for modeling a consumer decision process, the computer software comprising instructions to cause a computer system to perform the following functions:
receive information corresponding to a purchase decision from a first set of consumers, and using the information to determine a set of elements that impact the purchase decision;
determine a set of decision stages in the consumer decision process based on the set of elements;
validate the set of elements based on survey data received from a second set of consumers;
map the set of elements to the set of decision stages after the validating; and
assign impact scores to each of the set of elements for each of the set of decision stages.

25. The computer software of claim 24, wherein the instructions further cause the computer system to model the consumer decision process by developing a global map based on the mapping and the impact scores.
